(19) United States
(12) Patent Application Publication
(10) Pub. No.: US 2014/0120872 A1
(43) Pub. Date: May 1, 2014

(54) SYSTEMS AND METHODS FOR ALTERING THE PROPERTIES OF A MOBILE DEVICE IN RESPONSE TO A MAKE READY SIGNAL

(71) Applicant: DAVID AMIS, Durango, CO (US)

(72) Inventor: DAVID AMIS, Durango, CO (US)

(21) Appl. No.: 13/660,030

(22) Filed: Oct. 25, 2012

(51) Int. Cl. H04W 12/00

(52) U.S. Cl. 455/411

(57) ABSTRACT

The disclosure generally relates to systems and methods for allowing a person to transform their mobile device into a device optimized to provide security-related features and services. Users can initiate a Make Ready (MR) signal, to make their mobile device ready to output audio and video, capture audio, video, and biometric data, prolong battery life, enhance memory and processing capabilities specifically for security features, and increase the usability of the mobile device in a threatening situation.

### CROSS-REFERENCE TO RELATED APPLICATIONS

The present application is related to U.S. Non-Provisional patent application Ser. No. 12/862,117, filed on Aug. 24, 2010, which claims the benefit of U.S. Provisional patent application No. 61/236,265, filed on Aug. 24, 2009. The present application further claims the benefit of U.S. Provisional patent application No. 61/551,877, filed on Oct. 26, 2011. The contents of each of the afore-mentioned patent applications are hereby incorporated by reference in their entireties.

### BACKGROUND

1. Field of the Invention

The present invention relates generally to the field of personal safety management, and more specifically, to systems and methods optimizing a mobile device in order so that it can efficiently provide security-related features and services.

2. Description of Related Art

Recent advances in mobile computing and wireless technology have transformed traditional mobile phones into invaluable tools that help users with not only communicating with others, but also with managing all aspects of their personal lives and business activities. Mobile devices are increasingly being used for personal safety management as well, where mobile devices can be used to capture evidence, thwart potential perpetrators, and transmit an alarm for help.

However, mobile phones are very visually intensive devices, whereby users must look at the device in order to manipulate it. It is very difficult for current mobile devices to be correctly operated while the devices are concealed. A user cannot normally discern the current state of the device without looking at it, and therefore cannot be sure as to the current location or state of various on-screen buttons and controls at any given time. This makes it difficult to control the device while it is one's pocket, or while one is engaged in a situation or task that prevents one's ability to look at the device.

For example, consider a scenario when a victim is abducted and is being threatened with violence. In the presence of a perpetrator, it is likely that the victim is hesitant to take out their mobile phone in plain sight and call or text for help, since the perpetrator would most certainly escalate violence and/or confiscate or destroy the mobile phone. The victim is only a single call away from help, but ironically remains helpless because they cannot use their mobile phone in plain sight.

Therefore, there is a need for systems and methods that overcome the deficiencies of traditional mobile devices so that users can easily manipulate and operate a mobile device while it is concealed.

### SUMMARY

In an embodiment, the present invention provides a communication device for use in a concealed environment, comprising a casing; a communication means located within the casing; and at least one mechanical switch located on the casing, wherein the communication means is configured to transmit a signal to a remote location upon actuation of the mechanical switch.

In another embodiment, the present invention provides a communication device that provides haptic feedback, comprising a handset having a screen; a communication means coupled to the handset; and at least one pressure-sensitive trigger region located on a pre-determined portion of the screen, wherein the communication means is configured to transmit a signal to a remote location upon application of pressure to the trigger region.

In yet another embodiment, the present invention provides a mobile device for personal safety management, comprising a casing; a screen placed adjacent to the casing; at least one switch located on the casing or on the screen, the switch configured to provide tactile feedback; and a communication means located within the casing, the communications means configured to transmit a distress signal to a remote location signal upon receipt of a pre-determined input to the at least one switch.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic of personal safety communications network in accordance with an embodiment of the present invention;

FIG. 2A is a front view of a mobile device with protruding portions in accordance with an embodiment of the present invention;

FIG. 2B is a side view of a mobile device with protruding portions in accordance with an embodiment of the present invention;

FIG. 3A is a front view of a mobile device with protruding shaped portions in accordance with an embodiment of the present invention;

FIG. 3B is an elevated side view of a mobile device with protruding shaped portions in accordance with an embodiment of the present invention;

FIG. 4A is a front view of a mobile device with flush portions in accordance with an embodiment of the present invention;

FIG. 4B is a side view of a mobile device with flush portions in accordance with an embodiment of the present invention;

FIG. 5A is a side view of a mobile device with indented portions in accordance with an embodiment of the present invention;

FIG. 5B is a side view of a mobile device with an indented portion with a button in accordance with an embodiment of the present invention;

FIG. 6A is a front view of a mobile device with a mechanical slide switch in accordance with an embodiment of the present invention;

FIG. 6B is a side view of a mobile device with a mechanical slide switch in accordance with an embodiment of the present invention;

FIG. 7 is a front view of a mobile device with touch-sensitive buttons in accordance with an embodiment of the present invention;

FIG. 8 is a side view of a mobile device with a Braille-type manipulation system in accordance with an embodiment of the present invention;

FIG. 9 is a side view of a mobile device with an access switch in accordance with an embodiment of the present invention;

FIG. 10 is a front view of a mobile device with a dedicated alarm region on the screen in accordance with an embodiment of the present invention;

FIG. 11 is a front view of a mobile device with a dedicated slide region on the screen in accordance with an embodiment of the present invention; and

FIG. 12 is a flowchart illustrating the steps of triggering a distress signal in accordance with an embodiment of the present invention.

### DETAILED DESCRIPTION

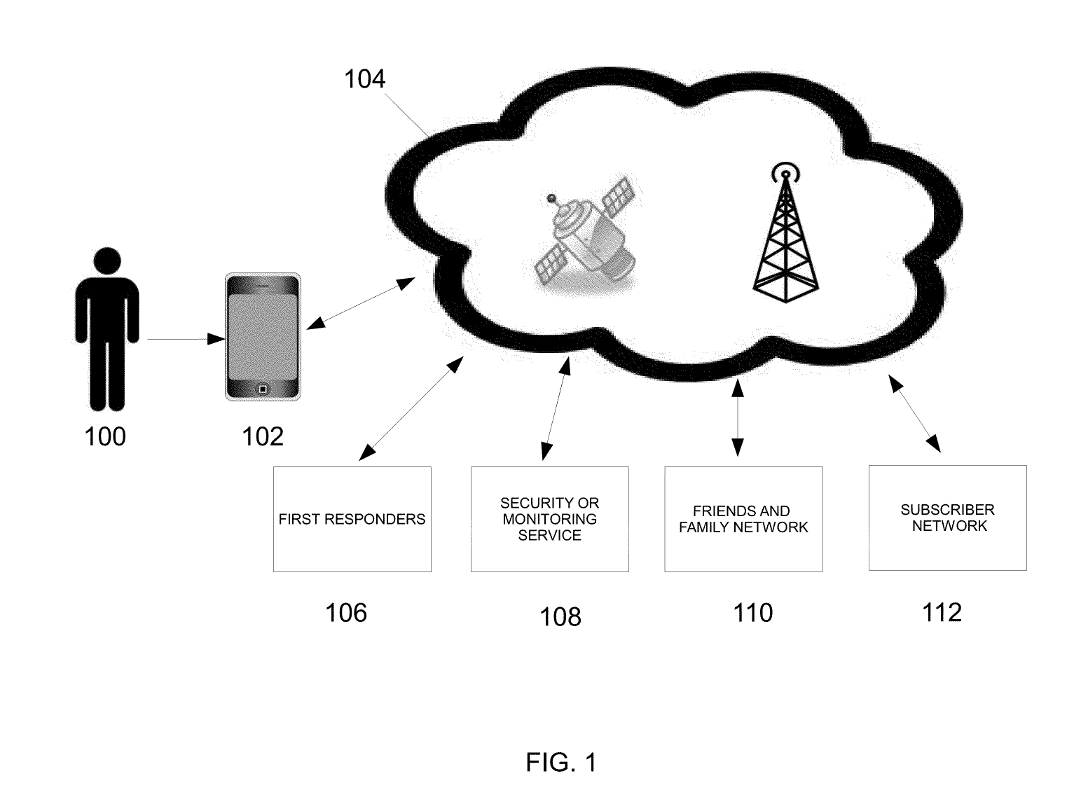

FIG. 1 is a schematic of personal safety communications network in accordance with an embodiment of the present invention. Referring to FIG. 1, the personal safety communications network can include a mobile device 102 which is located on or near the user 100. In a preferred embodiment, the user 100 can be a person, such as a child, elderly person, disabled person, a person living alone, a real estate agent, a mail courier, an undercover law enforcement agent, a postal delivery worker, a teenager, a single female, a disabled person, etc., each having a personalized suite of security services and third-party responses based on their activity, accessibility, vulnerability, and potential occupational hazards.

The mobile device 102 is communicatively coupled to a network 104, which can consist of a satellite communication system, at least one cellular phone tower, a wireless communication node, or any combination thereof. Furthermore, any type of standard or non-standard communication system/protocol which allows for positioning and data transmission can be used.

The network 104 is communicatively coupled to various third-party response providers, such as first responders 106, private monitoring/security providers 108, and/or a user's personal friends/family network 110.

The first responders 106 can include police departments, emergency medical service (EMS) providers, fire and rescue departments, volunteer organizations, volunteers, employees, 911 emergency centers, include federal agencies, task forces, non-governmental agencies, relief agencies and workers, and the military.

The user's personal friends/family network 110 can include a pre-determined list of contacts to which a distress signal is automatically transmitted. The contacts can receive a text message, multi-media message (MMS), email, Facetime alert, a phone call with a recorded distress message, live phone call from a 911 or private monitoring center dispatch, live audio from the user's mobile device, a social network notification (i.e., Facebook, MySpace, Orkut, LinkedIn, etc.), an instant messenger notification, or any combination thereof as an indication of the distress signal.

The private monitoring/security providers 108 can offer a subscription-based service that monitors the mobile device 102 as described in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein.

The safety communications network depicted in FIG. 1 allows for multi-directional (i.e., two-way, and three-way) communications. That is, a third-party response provider can receive data from the mobile device 102, and can also transmit data to the mobile device 102 via the network 104, as well as to the other third-party response providers.

The mobile device 102 can be a standalone personal safety device, or can be incorporated into a cellular phone, portable music player, keychain, pager, PDA, or other portable communication device. In another embodiment, the mobile device 102 can be worn on the user 100, such as around the user's neck (i.e., necklace or dog collar), ankle (i.e., anklet or ankle bracelet), or as a wristband (i.e., watch strap, watch). In a preferred embodiment, the mobile device 102 is a multi-function device that includes signal reception and transmission capabilities, and includes a cellular phone capability that allows the user 100 to communicate with a remote location.

In a preferred embodiment, the mobile device 102 is an off-the-shelf smart phone or device, such as an iPhone, iPod, iPad, Blackberry, Android, or other similar system. The off-the-shelf device can be loaded with applications or software that enables the off-the-shelf device to act as a mobile device 102 of this invention. For example, a user can download an application from the Internet, Android Marketplace, and/or the Apple Apps Store that includes facilitates the triggering of the distress signal by the user 100 as described below. In an embodiment, the user can pay a one-time or monthly subscription fee to the software provider to gain access to the downloadable applications. Alternatively, the user can download the applications for free, and receive a limited-time or limited-feature access to try the distress signal functionality. The user must then purchase a subscription to “unlock” the full capabilities and have unlimited access to the software application.

In another embodiment, the mobile device 102 is a standalone device that includes hardware features as described below. While software applications may be downloaded or programmed onto the mobile device 102, the casing, screen and physical construction of the device facilitate the triggering of the distress signal by the user 100.

The distress signal can be a data signal indicating an alarm, and can include position data. In an embodiment, the distress signal can also include audio data, so that once the distress signal is activated on the mobile device 102, a microphone on the mobile device 102 can capture and transmit any audible sounds from the user's environment to the third-party response provider in real-time. In yet another embodiment, a camera on the mobile device 102 can automatically be activated once the distress signal is activated. In the event the mobile device 102 is removed from its concealed location (i.e., pocket, purse, handbag, etc.), any video/image data from the user's environment will automatically be streamed to the third-party response provider in real-time. The audio and video data can also be stored on a memory located on the mobile device 102.

In yet another embodiment, the present invention is incorporated into a traditional land-line phone system, where the receiver does not need to be lifted in order for a distress signal to be transmitted to a third-party response provider. The landline phone base can have a dedicated button or set of buttons through which the user 100 can activate a distress signal. The buttons can be part of the keypad or located on another part of the phone base. For example, the user can enter a pre-determined sequence onto the keypad that triggers a distress signal (assuming that the keypad is on the base and not on the receiver). This embodiment may be applicable to hotel settings or environments which do not receive a strong wireless signal, and the only viable option to communicate is a landline phone.

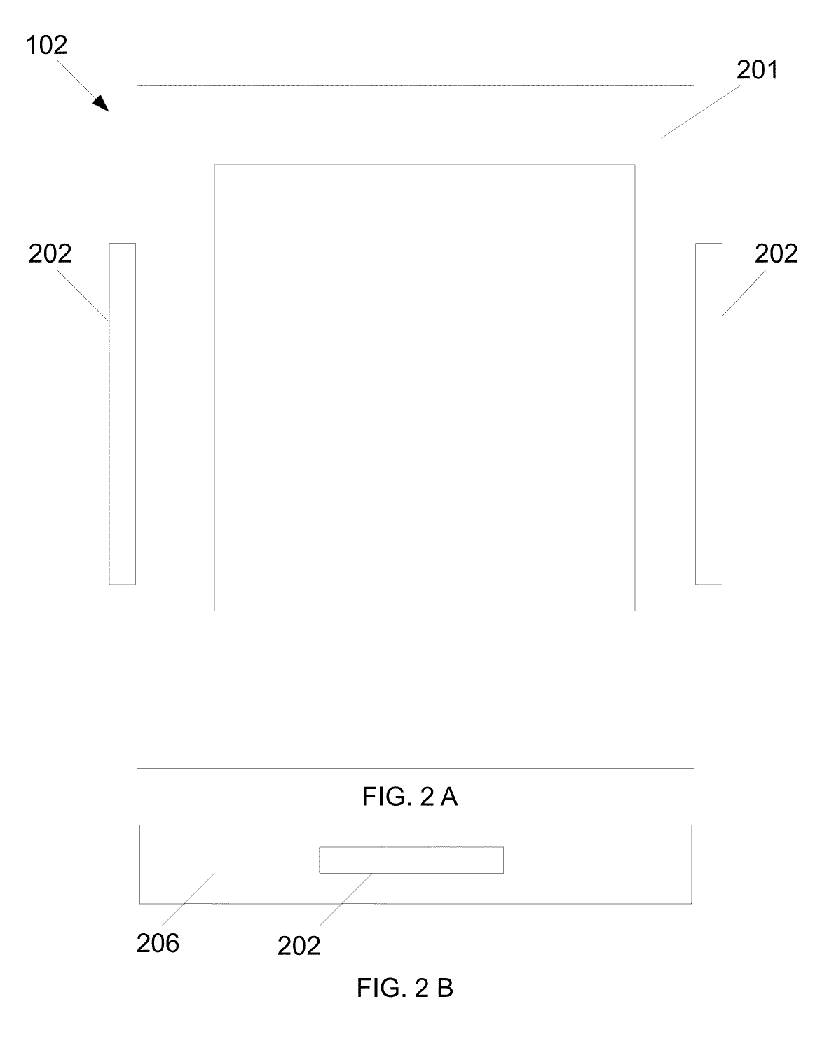

FIG. 2A is a front view of a mobile device 102 with protruding portions in accordance with an embodiment of the present invention. The mobile device 102 can include a casing 201 that has protrusions 202 located on each of the opposite sides of the casing 201. In an embodiment, the protrusions 202 are slightly raised from the casing 201, so that the user 100 can easily locate the protrusions 202 by feel. Upon a simultaneous depression of both protrusions 202, the mobile device automatically transmits a distress signal to a remote location, such as to at least one of the third-party response providers. For example, the user 100 can simply grasp the mobile device 102 and squeezes the protrusions 202 without having to look at the mobile device 102. Thus, the user 100 can activate the distress signal without taking it out of their pocket, purse, handbag, etc.

FIG. 2B is a side view of a mobile device 102 with protruding portions in accordance with an embodiment of the present invention. The protrusions 202 can be located on any side, front, or back portion of the casing 201, and their placement is not limited to the embodiment show in FIGS. 2A and 2B. Furthermore, multiple protrusions can be located on either side of the casing 201.

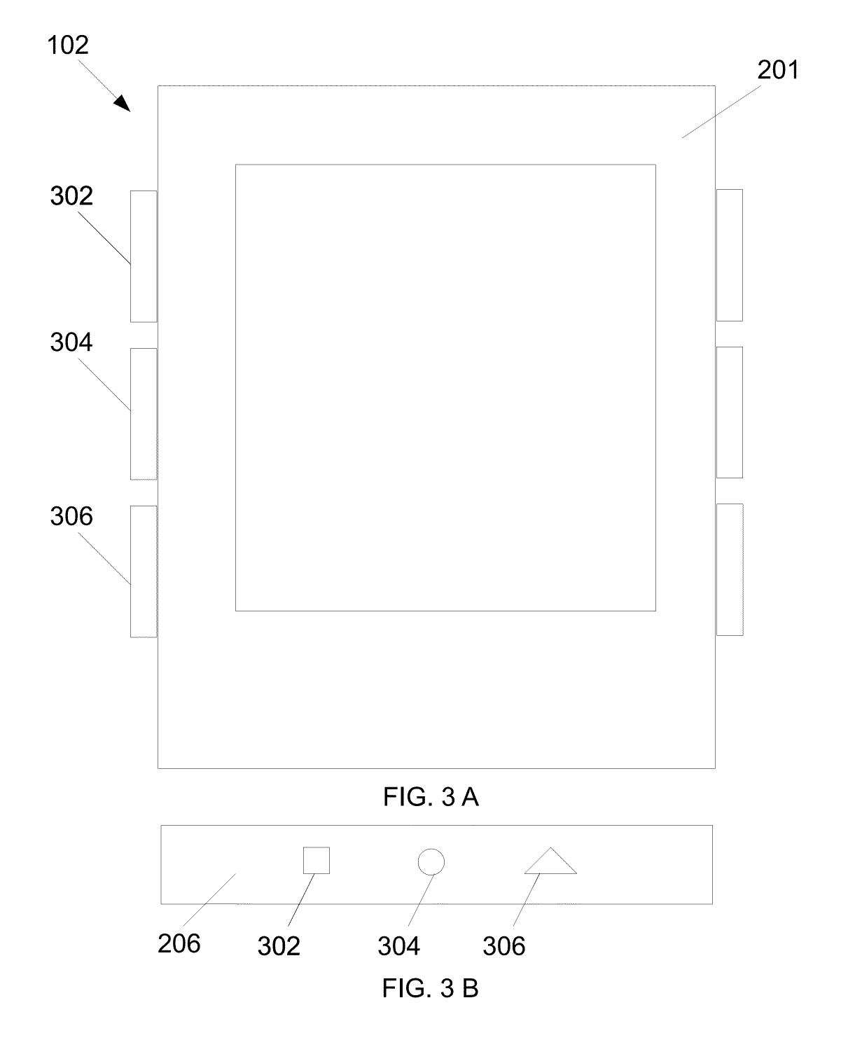

FIG. 3A is a front view of a mobile device with protruding shaped portions in accordance with an embodiment of the present invention. The casing 104 includes multiple protrusions 302-306, each of which has a unique shape as showing in FIG. 3B. For exemplary purposes, indentation 302 can be a square, indentation 304 can be a circle, and indentation 306 can be a triangle. The protrusions 302-306 can be located on a single side of the casing 104, or they can be located on any side, front, or back portion of the casing 201, and their placement is not limited to the embodiment show in FIGS. 3A and 3B.

In an embodiment, the user 100 can input a pre-determined sequence which can trigger a distress signal, such as (1) triangle, (2) square, (3) circle, or (1) circle, (2) circle, (3) square, etc. In this embodiment, the distress signal is only transmitted upon the exact sequence being entered into the mobile device 102, thus preventing accidental transmission of the distress signal.

In yet another embodiment, each of the different protrusions 302-306 can initiate a different command to the mobile device 102. For example, depression of the square protrusion 302 can initiate a distress signal. Depression of the circular protrusion 304 can activate audio capturing and transmission capabilities. Finally, depression of the triangular protrusion 306 can activate video/image capturing and transmission capabilities.

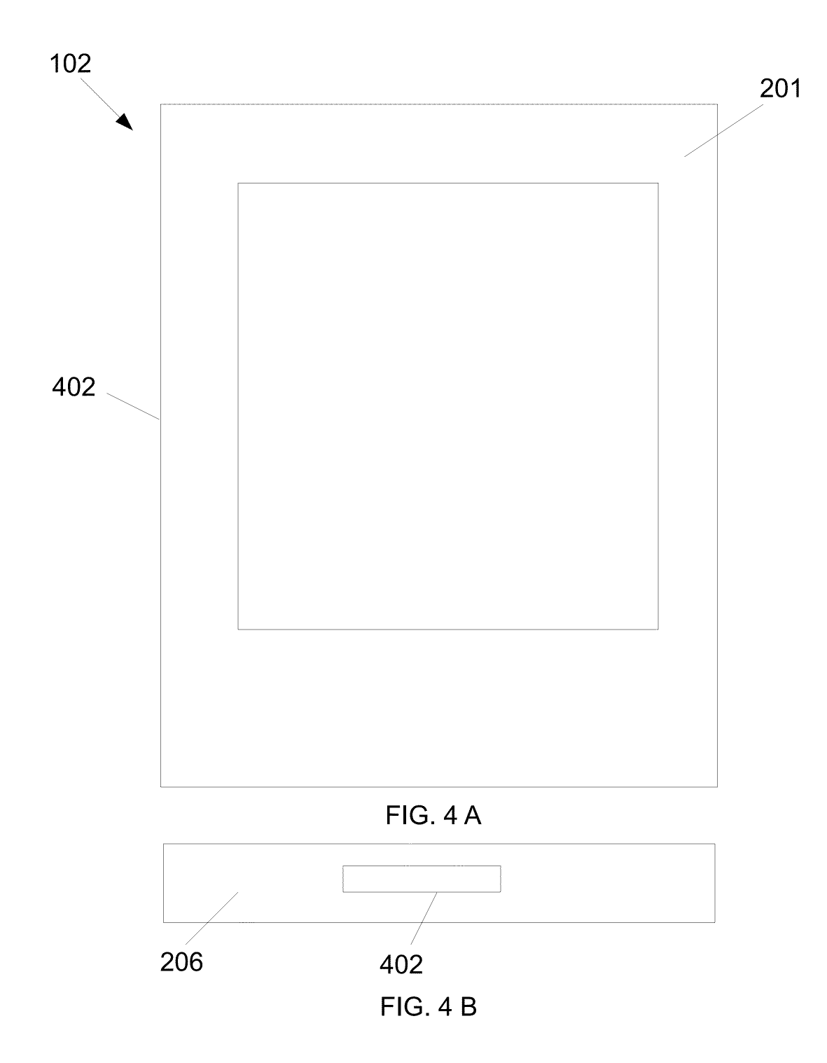

FIGS. 4A and 4B are front and side views, respectively, of a mobile device with flush portions in accordance with an embodiment of the present invention, respectively. The button 402 shown in FIG. 4B is on the same plane as the casing 104, so that it is not protruding or jutting out from the casing 104. Thus, the mobile device 102 has a clean, streamlined look. In this embodiment, the button 402 can be a haptic button, such that when the user 100 places their fingers over the button, the button 402 can vibrate or provide another touch-sensitive sensation to the user 100. The user 100 can easily locate the button 402 without looking at the mobile device 102 by simply feeling around for the haptic sensation.

In an embodiment, the button 402 can be located on any side, front, or back portion of the casing 201, and its placement is not limited to the embodiment show in FIG. 4B. Furthermore, multiple haptic buttons can be located on either side of the casing 201.

In yet another embodiment, multiple haptic buttons, each providing a different sensation can be utilized. For example, a first haptic button can provide a short vibration, while a second haptic button can provide a long vibration. The user 100 could then enter a sequence, such as, for example, two short haptic button presses and one long haptic button press, in order to trigger a distress signal.

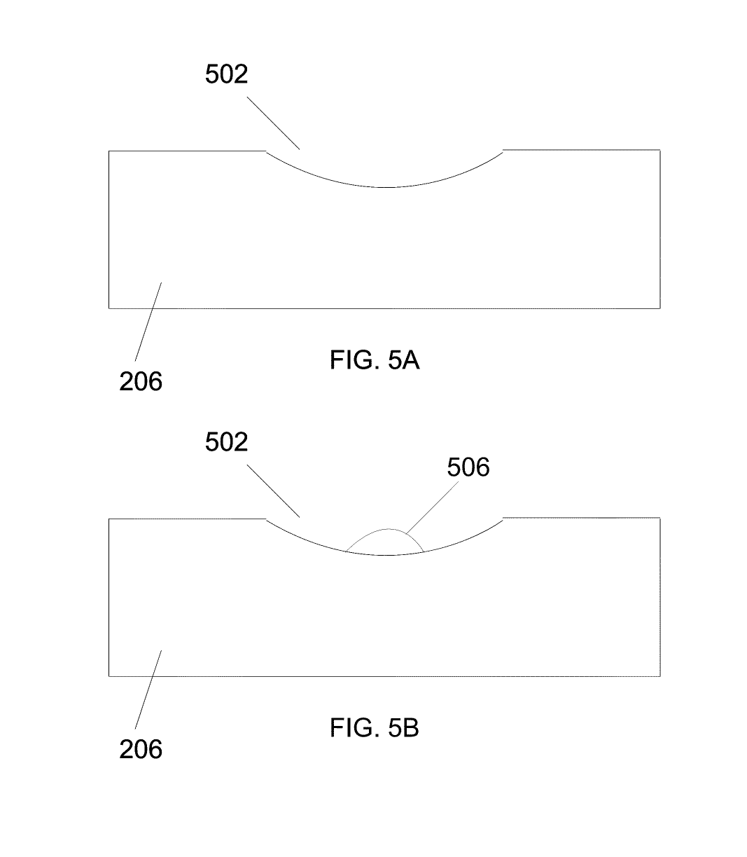

FIG. 5A is a side view of a mobile device with indented portions in accordance with an embodiment of the present invention. The mobile device 102 includes indentations 502 on the casing 201. The indentations 502 can include a touch sensitive layer 504 that can sense the user's finger pressure. Upon sensing the finger pressure, the distress alarm can be triggered. Similar to the other embodiments described above, the indentations 502 can be located on any side, front, or back portion of the casing 201, and its placement is not limited to the embodiment show in FIG. 5A. Furthermore, multiple indentations can be located on either side of the casing 201, and can be used in conjunction with each other so that the user can either simply apply pressure to one or more indentations simultaneously, or in a pre-determined sequence or order to trigger the distress alarm.

In yet another embodiment, the touch sensitive layer 504 can include fingerprint recognition technology. The mobile device 102 can include stored fingerprint data of multiple users. When the distress signal is sent, the fingerprint data of the user 100 is transmitted so that a third-party response provider can know the identity of the user 100.

FIG. 5B is a side view of a mobile device with an indented portion with a button in accordance with an embodiment of the present invention. In this embodiment, a button, such as a switch, click-button, slide-mechanism, tab, etc. is located within the indentation 502. Upon toggling the button, a distress signal is triggered.

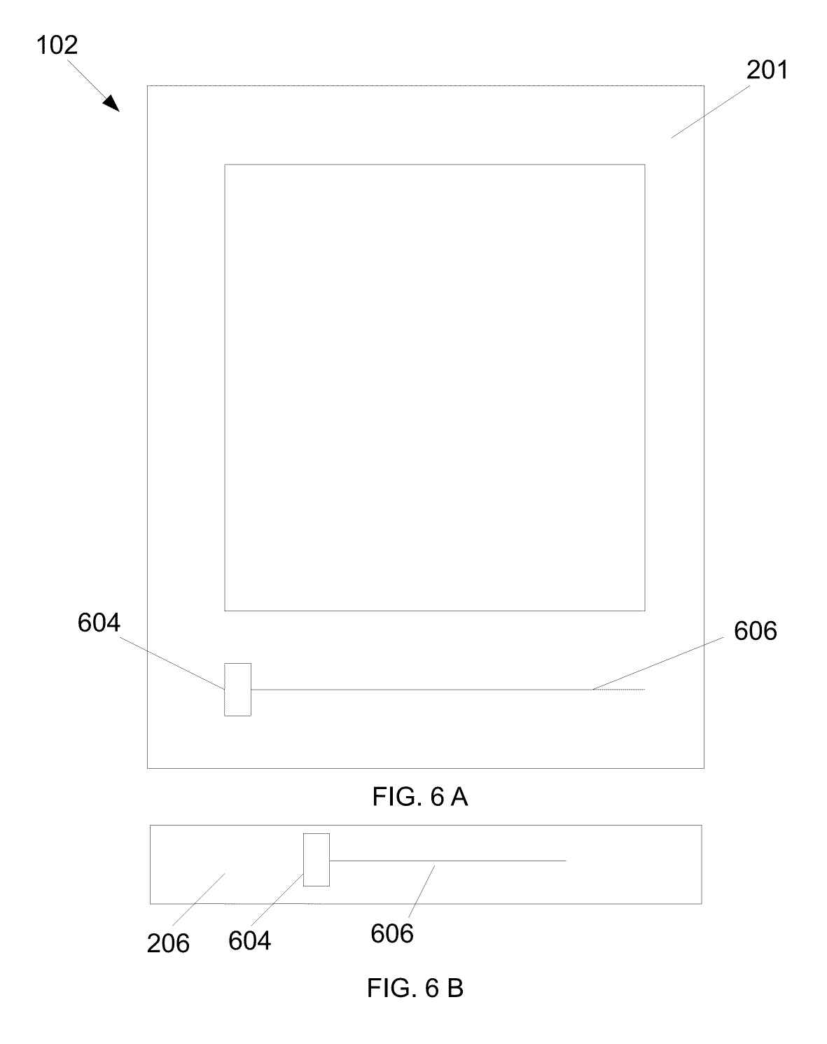

FIG. 6A is a front view of a mobile device with a mechanical slide switch in accordance with an embodiment of the present invention. The mobile device 102 includes a mechanical slide switch 604 on the casing 201. In an embodiment, the slide switch 604 is mounted on a runner 606. When the slide switch 604 is moved from one end of the runner 606 to the opposite end of the runner 606, and back again, within a pre-determined time period, a distress signal is triggered. For example, the distress signal would only be triggered if the user 100 moves the slide switch 604 back and forth two times within a three second period. The number of back-and-forth movements of the slide switch 604, and the time in which these number of movements needs to be completing in, can be pre-determined or pre-set by the user 100 or the mobile device manufacturer. The slide switch 604 and runner 606 can be located on any side, front, or back portion of the casing 201, and its placement is not limited to the embodiment show in FIG. 6A. FIG. 6B is side view of the mobile device 102 with the slide switch 604 located on the side 206 of the mobile device 102.

In yet another embodiment, instead of a slide switch, a rotary dial or turning dial can be used to trigger the distress signal.

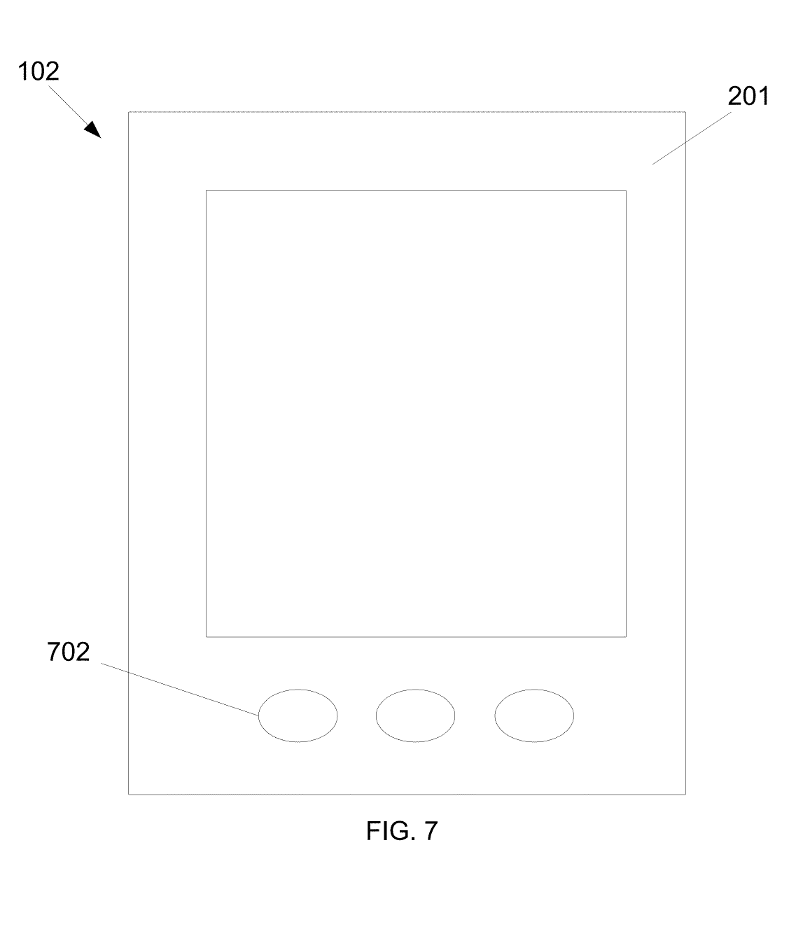

FIG. 7 is a front view of a mobile device with touch-sensitive buttons in accordance with an embodiment of the present invention. The mobile device 102 includes a plurality of touch-sensitive buttons 702 is located on the casing 201. In a preferred embodiment, the plurality of touch-sensitive buttons 702 are arranged in a straight row or column on the casing 201. In operation, the user 100 can slide their finger across the row or column of touch-sensitive buttons 702, effectuating a sliding motion. Such a movement would be difficult to emulate by accidental brushing while the mobile device 102 is in a pocket or purse.

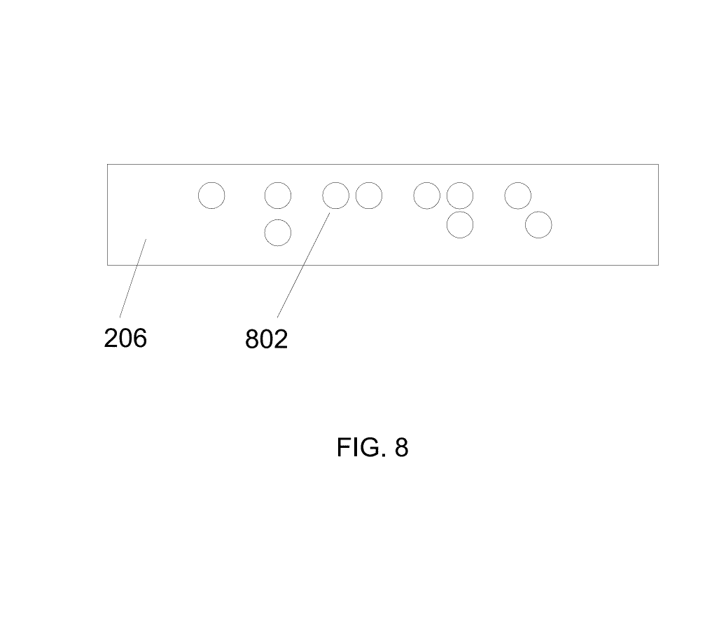

FIG. 8 is a side view of a mobile device with a Braille-type manipulation system in accordance with an embodiment of the present invention. The side 206 of the mobile device 102 (or any other portion of the casing 201) can include a Braille embossed section where the user 100 can trigger a distress signal, or send a message using the Braille alphabet. The message can be in the form of a text message or email that is transmitted from the mobile device 102 to a remote location.

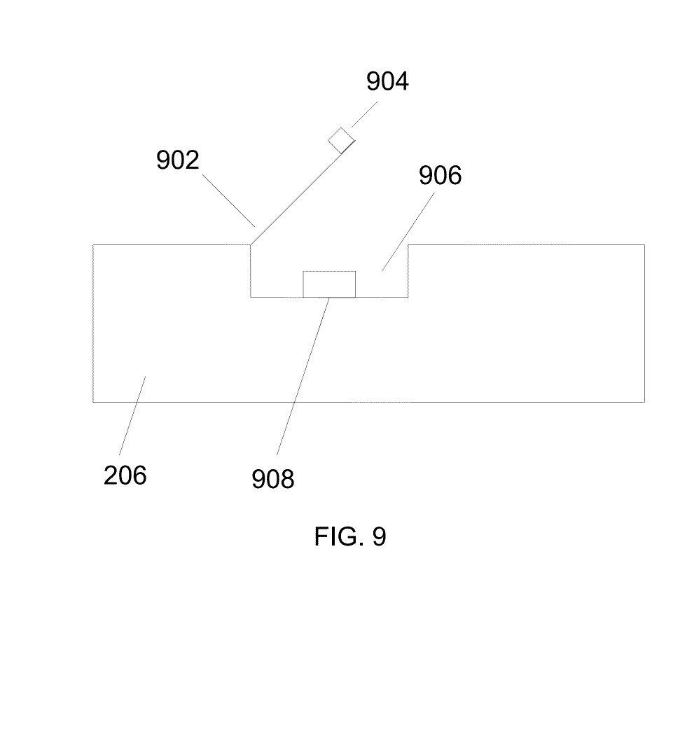

FIG. 9 is a side view of a mobile device with an access switch in accordance with an embodiment of the present invention. The casing 201 of the mobile device 102 includes an access port 906 having a liftable cover 902 supported by a hinge. In an embodiment, the cover 902 includes tactile portions so that a user can locate the cover 902 without looking at the mobile device 102. In yet another embodiment, the cover 902 is slidable, and can slide into the casing 201 to reveal the access port 906. Within the access port 906 is a recess having a button 908. The user 100 can depress the button 908 to trigger a distress signal.

In another embodiment, the access port 906 can include a touch sensitive layer, instead of a button, that can sense the user's finger pressure. Upon sensing the finger pressure, the distress alarm can be triggered.

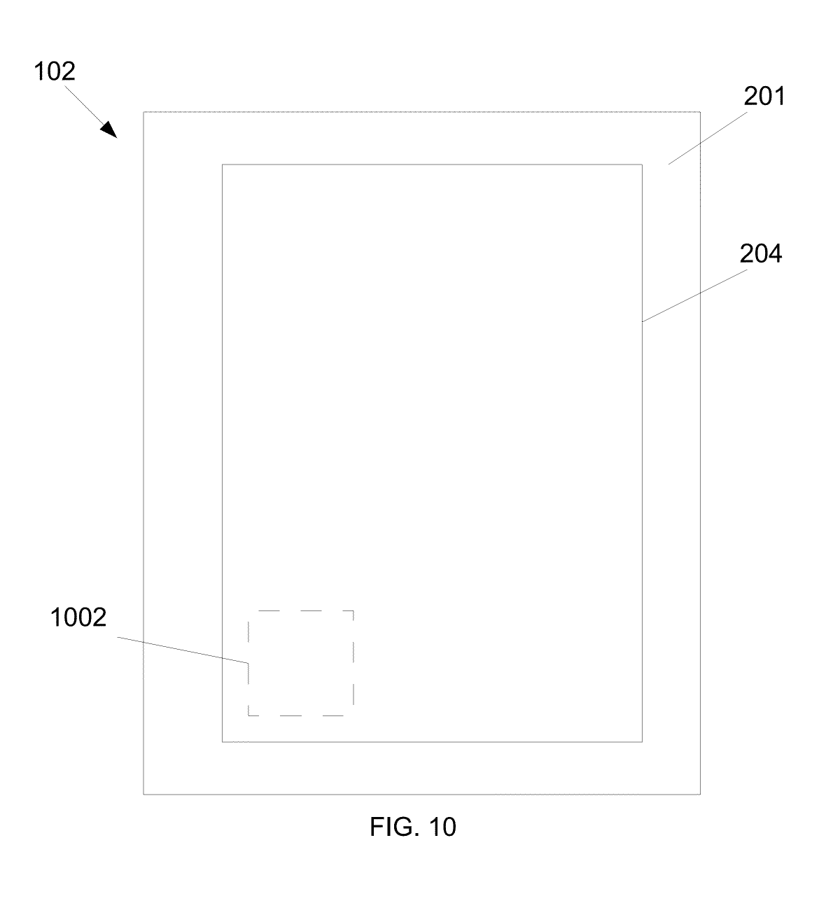

FIG. 10 is a front view of a mobile device with a dedicated alarm region on the screen in accordance with an embodiment of the present invention. The mobile device 102 includes a screen 204. Within the screen 204 is a dedicated region 1002 that the user 100 can touch in a pre-determined fashion to trigger a distress signal. In an embodiment, when the user's finger glides over the dedicated region 1002, a haptic sensation is triggered, indicating to the user 100 that they have located the dedicated region 1002. The user 100 can then enter an activation sequence of inputs, such as three long taps, or two short taps following by one long tap, etc. to trigger the distress signal.

The dedicated region 1002 can be software controlled, allowing for the user 100 or the mobile device manufacturer to set and modify the dedicated region 1002, as well as the activation sequence. In another embodiment, the dedicated region 1002 can be an embedded chip (i.e., hardware) placed within the screen 204. In this embodiment, the dedicated region 1002 is pre-set and cannot be changed. In yet another embodiment, the dedicated region 1002 is not on the screen 204, and can be on any portion of the casing 201 of the mobile device 102.

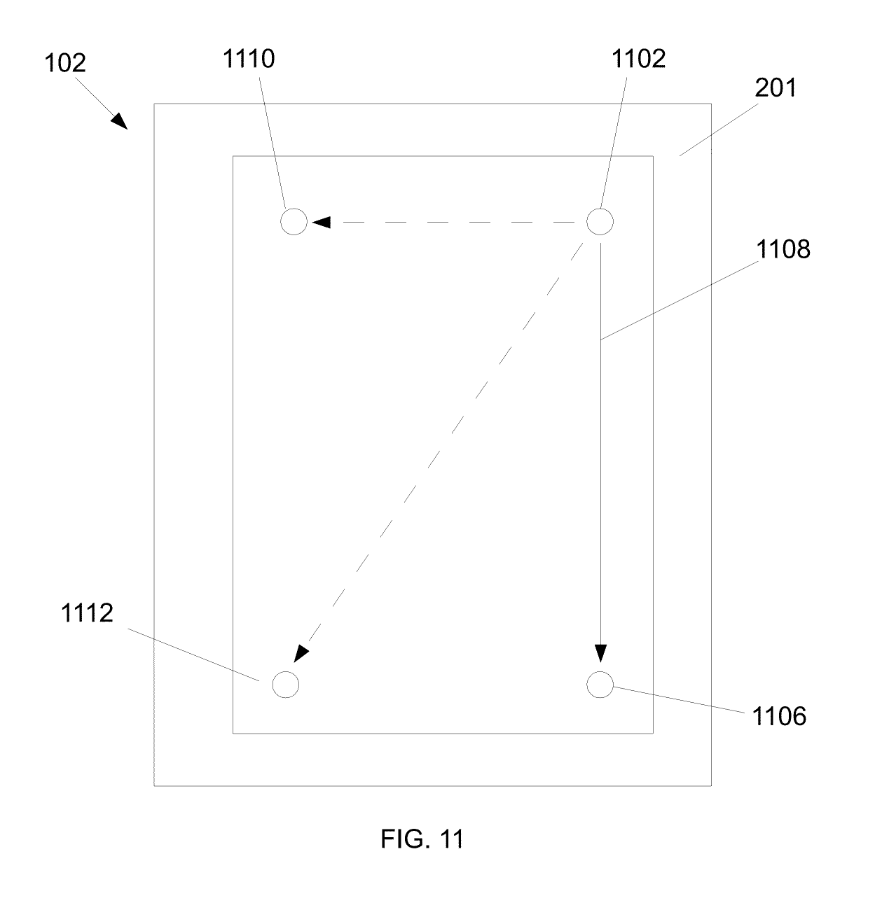

FIG. 11 is a front view of a mobile device with a dedicated slide region on the screen in accordance with an embodiment of the present invention. The mobile device 102 includes a screen 204 that is configured to sense a pre-determined sliding motion in order to trigger a distress signal. In an embodiment, when the user's finger glides over a starting point 1104, a haptic sensation is triggered, indicating to the user 100 that they have located the starting point 1104. In operation, the user 100 can slide their finger 1102 from the starting point 1104 to an ending point 1106 in the direction 1108 to trigger a distress signal. The starting point 1104 and the ending point 1106 can be software controlled, allowing for the user 100 or the mobile device manufacturer to set and modify the sliding region and start and end points. In yet another embodiment, more than two points can be used, such as three points connecting in a Z-shape pattern to trigger the distress signal.

In an embodiment, once the user 100 triggers the distress signal, an audible or visual indicator can be emitted from the mobile device 102. For example, an LED light on the mobile device 102 can be illuminated or can start to blink. In another example, a message can automatically be displayed on the screen 204 stating that a distress signal has been initiated. In another example, a pre-recorded message can automatically be played through a speaker on the mobile device 102.

In another embodiment, upon activation of the distress signal by the user 100, a pre-programmed event can be triggered in addition to the distress signal being transmitted to a third-party response provider. For example, the event can be turning on an automobile engine, activating an automobile or home security alarm system, turning on automobile or home lights, opening a garage door, locking or unlocking automobile or home doors and/or windows, activating a security camera or a web camera, etc.

Furthermore, the user 100 can enter a different sequence or touch a different combination of buttons or touch points on the mobile device 102 in order to activate different events. For example, referring to FIG. 11, as mentioned earlier, a vertical finger swipe from starting point 1104 to ending point 1106 can trigger a distress signal. In an embodiment, a horizontal swipe from starting point 1104 to ending point 1110 can trigger an event signal for turning on an automobile engine. Whereas a diagonal swipe from starting point 1112 to ending point 1110 can trigger an event signal to activate a home security alarm system.

In each of the embodiments described in FIGS. 2-11, the mobile device 102 can be in a locked or sleep state in the user's pocket, purse, handbag, etc. in order for the various distress signal triggering mechanisms to be activated. By having the device in a locked state, this would prevent the accidentally triggering of the distress signal.

In an embodiment, the mobile device 102 can include accelerometers and/or gyroscope mechanisms to determine its physical orientation. When the orientation is in flux based on accelerometer and gyroscope readings, this can be an indication that the device is in a pocket, purse, handbag, etc., and the mobile device 102 can automatically be placed in a locked mode, thereby enabling the distress signal triggering mechanisms.

In yet another embodiment, the mobile device 102 can include a camera. When the camera senses a transition from a lighted environment to a dark environment, indicating that the device has been placed in a pocket or handbag, the mobile device 102 can automatically be placed in a locked mode, thereby enabling the distress signal triggering mechanisms.

In another embodiment, if the mobile device 102 is in a purse, handbag, backpack, etc., the accelerometers and/or gyroscope mechanisms can determine if the user 100 is swinging their bag in a manner consistent with using the bag as a defensive tool. For example, if a woman is being chased or attacked, she may use her purse to beat or fend off the perpetrator. The swinging motion of the purse is likely to be extremely erratic. Upon sensing this erratic motion by the accelerometers and/or gyroscope mechanisms, the mobile device 102 inside the purse can trigger a distress signal.

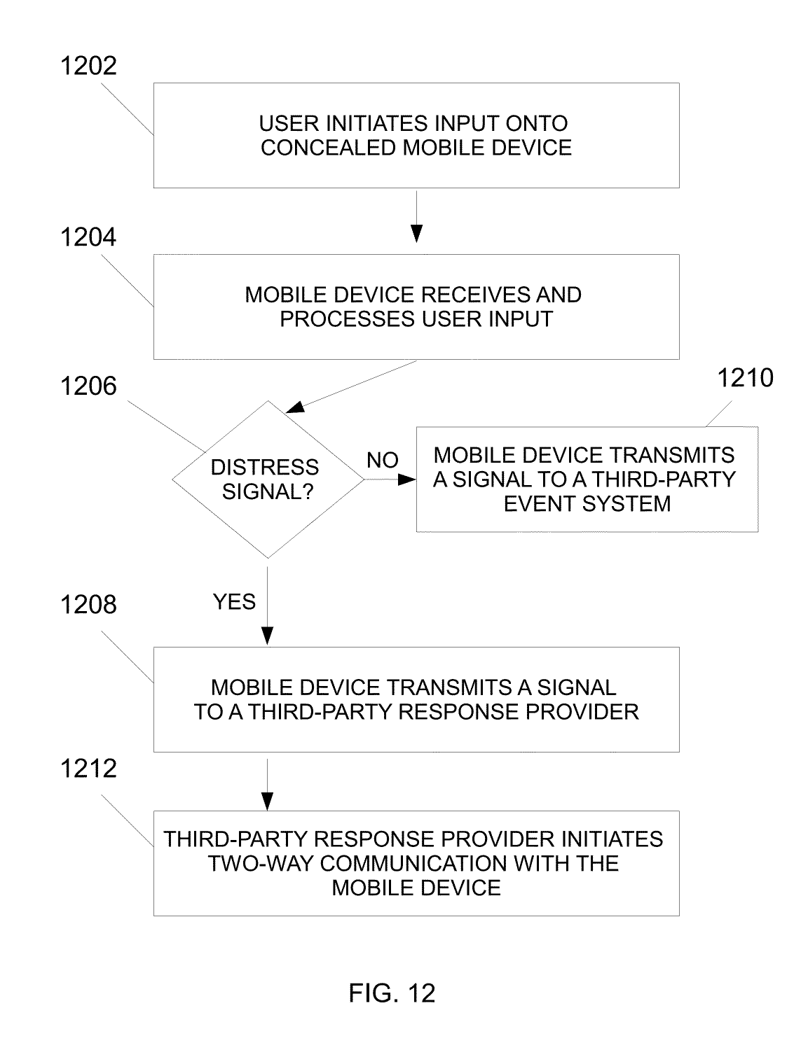

FIG. 12 is a flowchart of the method of triggering a distress signal in accordance with an embodiment of the present invention. In step 1202, the user 100 initiates an input according to one of the aforementioned methods that does not require the user 100 to look at the mobile device 102. Next, in step 1204, the mobile device 102 receives an input signal corresponding to the user input, and subsequently processes the input to determine a corresponding action. In step 1206, the mobile device 102 determines if the input signal corresponds to a distress signal, or to an event signal.

If the input signal corresponds to a distress signal, then in step 1208, the mobile device 102 transmits a distress signal to a remote location, such as to a third-party response provider. The distress signal can include position, audio, and video/image data, as well as any other identifying or information data that can assist the third-party response provider in assessing the user's environment/situation.

Alternatively, if the input signal corresponds to an event signal, then in step 1210, the mobile device 102 transmits an event signal to a third-party event system, such as a home security system, an automobile controller, etc.

In step 1212, the third-party response provider can initiate a two-way communication with the mobile device 102. For example, the third-party response provider can speak through a speaker or loudspeaker on the mobile device 102. In another embodiment, the third-party response provider can trigger an audible alarm or a pre-recorded message stating that the situation is being monitoring, and law enforcement officials are en route to the scene.

In another embodiment, instead of sending an automatic distress signal upon receipt of the aforementioned methods, the mobile device 102 can include a “Release 911” feature, which was described as “911-On-Call” in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein. Upon feeling uncertain or uneasy about a particular environment or situation, the user 100 can activate a stand-by signal by applying a constant, steady pressure to a certain portion of the mobile device 102. This stand-by signal is transmitted to a third-party response provider.

For example, the user 100 can depress a button, or touch a portion of the mobile device 102, in a pre-determined fashion as described above. As long as the user 100 keeps a constant, steady pressure on this particular portion of the mobile device 102, the stand-by signal is transmitted to a third-party response provider, namely a 911 emergency center or a private monitoring/security provider. Upon receipt of the stand-by signal, the response provider is put on alert that the user 100 is in a potentially threatening situation, but perhaps not necessarily in immediate danger. If the user 100 removes pressure from the portion of the mobile device 102, such as loosening their grip or letting go of the mobile device 102, the third-party response provider requests the user 100 to enter a code (either by input into the mobile device 102, or an audible code) to verify that the user 100 is not in danger. If such as input is not received within a pre-determined period of time, the third-party service provider escalates the situation in order to provide immediate assistance to the user 100.

In another embodiment, the distress signal can be triggered by voice commands. For example, the mobile device 102 can have an active microphone, such that the microphone is constantly picking up audible sounds, and the mobile device 102 is constantly processing these sounds in real-time. In the event of an attack, if the user 100 yells certain distress words, such as “Rape”, “Help”, “Attack”, “Burglar”, “Kidnapping”, “Robbery”, etc., the distress signal is automatically triggered. The microphone can be a highly sensitive microphone that can detect sounds even while the mobile device is in a concealed environment.

In another embodiment, the mobile device 102 can include voice recognition software so that only a registered user's voice can activate the distress signal. In another embodiment, a family may choose to register the voices of all family members (e.g. parents, children, elderly grandparents) into the mobile device 102 so that it can be activated by numerous family members.

In yet another embodiment, the distress signal can be triggered based on the user's physiological condition. The user 100 can have body sensors communicatively coupled to the mobile device 102 that are specifically tuned to recognize extreme stress consistent with attack, robbery, rape, hostage, and/or kidnapping situations. For example, the mobile device 102 can monitor the heart rate of the user 100. If the user's heart rate becomes abnormally elevated, is erratic, or if no pulse is detected, a distress signal is automatically triggered. In this embodiment, the mobile device 102 is communicatively coupled to the user's body sensors via short-range wireless communication protocols, such as RFID or Bluetooth.

In yet another embodiment, upon receipt of an indication, such as a button press, touch screen input, remote distress signal, accelerometer, gyroscope, or other internal or external sensor reading, the mobile device 102 can be optimized so that it can more effectively provide security and response features. Such functionality is coined “Make Ready 911”.

In an embodiment, upon receiving the Make Ready 911 indication, software on the mobile device 102 configures various settings of the device. For example, the microphone on the mobile device 102 can be optimized so that the recording volume of audible sounds is increased, memory on the mobile device 102 can be made available for storing captured sounds, and filters can be activated to process received remove unwanted noise and static to increase the quality of recorded sounds. In addition, the sound capturing distance of the microphone can be adjusted.

In yet another embodiment, the memory on the mobile device 102 is parsed and any non-essential data, such as Internet browser cache or temporary files are deleted in order to maximize space for any security-related data capture and storage. In addition, the volume of the speaker on the mobile device 102 can be increased or decreased based on the user's environment. For example, if the mobile device 102 senses a high degree of ambient sound, the speaker volume is increased so that the mobile device 102 speaker can be heard in the environment.

In another embodiment, the speaker volume on the mobile device 102 can automatically be adjusted to its highest or lowest levels, based on a pre-defined user setting.

Furthermore, the sensitivity of the display on the mobile device 102 can be increased or decreased. In an embodiment, the capacitance of a touch screen or touch sensitive display can be increased so that a lighter touch or a touch of a shorter duration is recognized and processed by the mobile device 102. In another embodiment, the capacitance of the touch screen or touch sensitive display can be decreased so that a harder touch or a touch with a more prolonged duration is required for the touch to be recognized and processed by the mobile device 102.

In yet another embodiment, the sensitivity of a physical button or set of buttons on the mobile device 102 can be adjusted so that a higher or lower amount of pressure is required to actuate the button.

In another embodiment, the threshold of voice recognition capabilities of the mobile device 102 is reduced so that typical phrases that would not be considered a command or a distress call would be recognized and processed. For example, yelling “Help!” would traditionally elicit a response protocol by the mobile device 102. After the mobile device 102 is enhanced in anticipation of a security or risk, the voice recognition software would also process common misspellings such as “hell” or “yelp” or “elp”, in order to capture muffled sounds that could be emitting by the victim during an attack.

In an embodiment, the processor can filter audible sounds and voice and isolate pre-determined words, phrases, and voices to identify or discern events around the mobile device 102. For example, the mobile device 102 can proactively listen for names of people spoken aloud that match any names of contacts stored on the mobile device 102. In addition, the mobile device 102 can filter in or out the voice of the registered user, and isolate any other sounds for processing or transmission to a remote center.

In yet another embodiment, the sensitivity of motion and movement sensors on the mobile device 102 can be adjusted to a heightened or lessened sensitivity. For example, accelerometers and gyroscopes on the mobile device 102 can be adjusted so that a drop, shake, swinging, throwing, or pull-cord type movement can more easily be determined and sensed, which can then in turn be used to activate other features or provide data to the mobile device 102 and/or remote monitoring center. The orientation sensitivity, velocity sensitivity, and rotational sensitivity can each be adjusted.

In addition, the mobile device 102 can automatically terminate, close, and/or disable all non-essential applications or features, such as video and music players, Internet browsers, and games, so that the processor and battery of the mobile device 102 can be fully utilized for the security features described above. Furthermore, the brightness of the display on the mobile device 102 can be dimmed in order to conserve battery life or increased in order to maximize viewing or attention.

In yet another embodiment, the mobile device 102 can enter a shock mode, where the internal electronic components and circuitry are locked so that they are resistant to movement, thereby helping to prevent a memory loss due to a drop or impact on the mobile device 102.

The mobile device 102 can further enter a locked mode or initiate neuron jamming procedures if, after initiation of Make Ready 911, no further input is received from the user, or if the user's voice is no longer detected, operation and manipulation of the phone can be disabled. The only features active on the phone would be audio and video capture and recording functions, as well as third-party communication functions, so that the mobile device 102 can continue to capture and transmit data to a remote location for processing, even if the user is no longer deemed to be manipulating the mobile device 102.

While the principles of the disclosure have been illustrated in relation to the exemplary embodiments shown herein, the principles of the disclosure are not limited thereto and include any modification, variation or permutation thereof.

What is claimed is:

1. A method of enhancing a mobile device to provide optimized security features, comprising:
receiving, at a processor, a make ready (MR) signal from a sensor; and
adjusting, by the processor, a sensitivity of at least one hardware component on the mobile device,
wherein the hardware component is selected from a group consisting of a speaker, a microphone, a touch sensitive area, an accelerometer, and a gyroscope.

2. The method of claim 1, wherein the MR signal is initiated due to a pressure applied to a portion of the mobile device.

3. The method of claim 1, wherein the MR signal is initiated due to an audible sound captured by the microphone.

4. The method of claim 1, wherein the MR signal is initiated due to a velocity value measured by the accelerometer.

5. The method of claim 1, wherein the MR signal is initiated due to an orientation value measured by the gyroscope.

6. The method of claim 1, wherein the sensitivity of the hardware component is increased.

7. The method of claim 1, wherein the sensitivity of the hardware component is decreased.

8. A method of preparing a mobile device to optimize the use of various security-related features, comprising:
receiving, at a processor, a make ready (MR) signal from a sensor;
adjusting, by the processor, a sensitivity of at least one hardware component on the mobile device, wherein the hardware component is selected from a group consisting of a speaker, a microphone, a touch sensitive area, an accelerometer, and a gyroscope; and
terminating, by the processor, a non-essential function of the mobile device, wherein the non-essential function is selected from a group consisting of a music player, a video player, an Internet browser, and a gaming application.

9. The method of claim 8, wherein the sensor is an accelerometer.

10. The method of claim 8, wherein the sensor is a gyroscope.

11. The method of claim 8, wherein the sensor is a microphone.

12. The method of claim 8, wherein the sensor is a pressure sensor.

13. A mobile device optimized for the use of various security-related features, comprising a processor configured to receive a make ready (MR) signal from a sensor, the processor further configured to generate a control signal;
a microphone coupled to the processor, the microphone configured to adjust at least one of a recording volume sensitivity, a recording filter sensitivity, and a recording distance sensitivity, upon receipt of the control signal;
a speaker coupled to the processor, the speaker configured to adjust at least one of an output volume, an output tone, and output audible frequency, upon receipt of the control signal; and
a capacitive surface coupled to the processor, the capacitive surface configured to adjust at least one of a pressure level sensitivity and a pressure duration sensitivity.

14. The mobile device of claim 13, further comprising a voice recognition processor, the voice recognition processor configured to focus on at least one of a pre-determined voice, sound, or word, upon receipt of the control signal.

15. The mobile device of claim 13, further comprising a motion sensor configured to adjust at least one of an orientation sensitivity, a velocity sensitivity, and a rotational sensitivity.

16. The mobile device of claim 13, further comprising a voice recognition processor, the voice recognition processor configured to analyze misspellings of audible words, upon receipt of the control signal.

17. The mobile device of claim 13, wherein the processor is further configured to disable at least one of a music player, video player, Internet browser, and a gaming application, upon receipt of the MR signal.

18. The mobile device of claim 13, wherein the processor is further configured to dim a display screen on the mobile device upon receipt of the MR signal.

19. The mobile device of claim 13, wherein the processor is further configured to activate a movement on a hardware component within the mobile device upon receipt of the MR signal.

20. The mobile device of claim 13, further comprising a memory module, the memory module configured to delete non-essential data upon receipt of the control signal.
